(19) United States
(12) Patent Application Publication
(10) Pub. No.: US 2009/0164529 A1
(43) Pub. Date: Jun. 25, 2009

(54) Efficient Backup of a File System Volume to an Online Server

(76) Inventor: Greg McCain, San Luis Obispo, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/962,697

(22) Filed: Dec. 21, 2007

(51) Int. Cl. G06F 17/30

(52) U.S. Cl. 707/204; 707/E17.01

(57) ABSTRACT

Various embodiments of a system and method for performing a backup operation to backup a volume formatted according to a particular file system to an online server computer system are disclosed. Backing up the volume may include backing up both the data files and the file system metadata of the volume. Various techniques may be utilized to avoid duplication of data on the server computer system and reduce the amount of data transmitted over the network. The backup information created on the server computer system may be useable to perform a complete restore of the volume on the client computer system, e.g., in the event of a storage device failure on the client computer system.

### BACKGROUND OF THE INVENTION

1. Field of the Invention

This invention relates to a system and method for efficiently backing up a file system volume from a client computer system to an online server computer system.

2. Description of the Related Art

Computer systems generally store information as data files. The data files are typically included in volumes that represent a logical partitioning and/or aggregation of physical storage provided by one or more storage devices. A volume may be formed from a subset (e.g., less than all) of the overall storage of a storage device, all of the storage of a storage device, or from the storage of multiple storage devices combined.

A volume is typically formatted according to a particular file system, such as an NTFS file system, a FAT file system, a UNIX-based file system, etc. The volume may include a plurality of data files managed by the file system, as well as metadata used by the file system to manage or implement the volume.

If a storage device fails then the data files stored on the storage device may be lost. Thus, it is often desirable to backup the data files in a volume. However, even if all of the data files in a volume are backed up, it can still be difficult and time-consuming to restore the volume and get the computer system back into a functional state unless the metadata used by the file system to manage or implement the volume is also backed up.

### SUMMARY

Various embodiments of a system and method for backing up a volume formatted according to a particular file system to an online server computer system are disclosed. The volume may be formatted according to a particular file system and may include a plurality of data files and metadata of the file system. Backing up the volume may include backing up both the data files of the volume and the file system metadata of the volume. Various techniques may be utilized to avoid duplication of data on the server computer system and reduce the amount of data transmitted over the network. The volume information created on the server computer system may be useable to perform a complete restore of the volume on the client computer system, e.g., in the event of a storage device failure on the client computer system.

According to some embodiments of the method, a backup operation may be performed to backup a volume of a first computer system to a second computer system. Performing the backup operation may comprise determining which of the plurality of data files of the volume are not already stored on the second computer system and transmitting to the second computer system only the data files that are not already stored on the second computer system. The metadata of the file system may also be transmitted to the second computer system. Catalog information may also be transmitted to the second computer system, where the catalog information specifies the plurality of data files in the volume and associates the plurality of data files in the volume with the metadata of the file system.

For each data file transmitted to the second computer system in the first backup operation, the second computer system may store the data file in response to receiving the data file, e.g., by creating a corresponding data file in a file system on the second computer system. Data files of the volume that are not transmitted to the second computer system in the first backup operation may have already been stored on the second computer system before the first backup operation was performed. For example, in some embodiments one or more of the data files not transmitted to the second computer system in the first backup operation may have been previously stored on the second computer system in a previous backup operation. In other embodiments, the second computer system may have been pre-seeded with one or more common files by an administrator of the second computer system, e.g., where the common files were stored on the second computer system, but were not stored in response to a backup operation. Thus, one or more of the data files not transmitted to the second computer system in the first backup operation may have been previously stored on the second computer system as one of the common files with which the second computer system was pre-seeded.

The catalog information may reference each of the plurality of data files in the volume. For the data files transmitted to the second computer system in the first backup operation, the catalog information may reference the data files created by the second computer system in response to receiving the data files from the first computer system during the first backup operation. For the data files not transmitted to the second computer system in the first backup operation, the catalog information may reference the corresponding data files that were already stored on the second computer system before the first backup operation was performed.

### BRIEF DESCRIPTION OF THE DRAWINGS

A better understanding of the invention can be obtained when the following detailed description is considered in conjunction with the following drawings, in which:

FIG. 1 illustrates one embodiment of a system including a client computer system and a server computer system, in which a volume stored on the client computer system is backed up to the server computer system;

FIG. 2 illustrates data files and file system metadata stored on the server computer system in response to a backup operation;

FIG. 3 illustrates an example in which the client computer system sends a request specifying one or more desired data files to the server computer system, and in response, the server computer system returns the specified data file(s) to the client computer system;

FIG. 4 illustrates catalog information stored on the server computer system in response to a backup operation, where the catalog information represents a first point-in-time backup of the volume;

FIG. 5 illustrates the example of FIG. 4 after an additional backup operation has been performed, where additional catalog information representing a second point-in-time backup of the volume has been stored on the server computer system;

FIG. 6 illustrates an example in which the server computer system has been pre-seeded with common data files;

FIG. 7 illustrates an example in which three data files and corresponding signature information are stored on the server computer system;

FIGS. 8 and 9 illustrate examples in which data files have been split into segments;

FIG. 10 illustrates one embodiment of the client computer system; and

FIGS. 11 and 12 illustrate embodiments of the server computer system.

While the invention is susceptible to various modifications and alternative forms, specific embodiments thereof are shown by way of example in the drawings and are described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

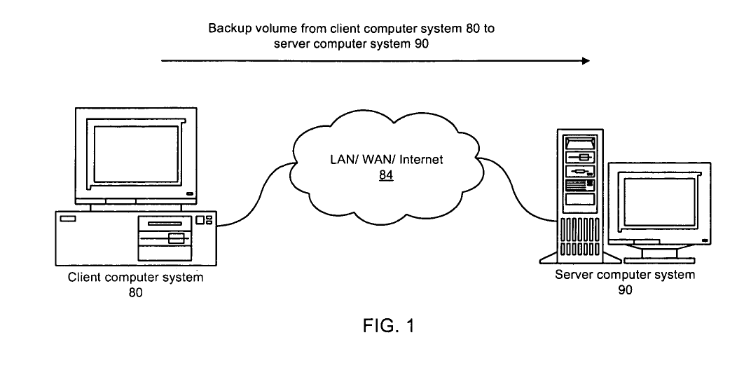

Various embodiments of a system and method for backing up a file system volume are disclosed herein. As illustrated in FIG. 1, the system may include a client computer system 80. The client computer system 80 may include or may be coupled to one or more storage devices that store a volume formatted according to a particular file system. For example, in some embodiments the volume may be stored on one or more hard disk drives included in or coupled to the client computer system 80. For convenience, the volume stored on the one or more storage devices included in or coupled to the client computer system 80 is also referred to herein as “the volume stored on the client computer system 80” or simply “the volume of the client computer system 80”.

In various embodiments the client computer system 80 may be any type of computer system, and the volume stored on the client computer system 80 may be formatted according to any file system. For example, in some embodiments the volume may be an NTFS volume, e.g., a volume formatted according to an NTFS file system. In other embodiments the volume may be a FAT volume, e.g., a volume formatted according to a FAT file system. In other embodiments the volume may be a UNIX-based volume, e.g., a volume formatting according to a UNIX-based file system.

The system may also include a server computer system 90. The client computer system 80 and the server computer system 90 may be coupled via a network 84. In various embodiments, the network 84 may include any type of network or combination of networks. For example, the network 84 may include any type or combination of local area network (LAN), a wide area network (WAN), wireless networks, an Intranet, the Internet, etc. Examples of local area networks include Ethernet networks, Fiber Distributed Data Interface (FDDI) networks, and token ring networks. The client computer system 80 and server computer system 90 may each be coupled to the network 84 using any type of wired or wireless connection medium. For example, wired mediums may include Ethernet, fiber channel, a modem connected to plain old telephone service (POTS), etc. Wireless connection mediums may include a wireless connection using a wireless communication protocol such as IEEE 802.11 (wireless Ethernet), a modem link through a cellular service, a satellite link, etc.

Client backup software executing on the client computer system 80 may be operable to backup the volume stored on the client computer system 80 by transmitting data from the volume to the server computer system 90 via the network 84. More particularly, the volume may include a plurality of data files 60 and file system metadata 70, and the client computer system 80 may transmit the data files 60 and the file system metadata 70 to the server computer system 90. In some embodiments, each data file 60 may be transmitted to the server computer system 90 separately from the other data files 60 and separately from the file system metadata 70.

The server computer system 90 may store the data files 60 of the volume and the file system metadata 70 of the volume on one or more storage devices 125 included in or coupled to the server computer system 90. The data files 60 of the volume and the file system metadata 70 of the volume may represent a point-in-time backup of the volume, e.g., may represent the state of the volume as it existed at the point in time when the volume was backed up to the server computer system 90.

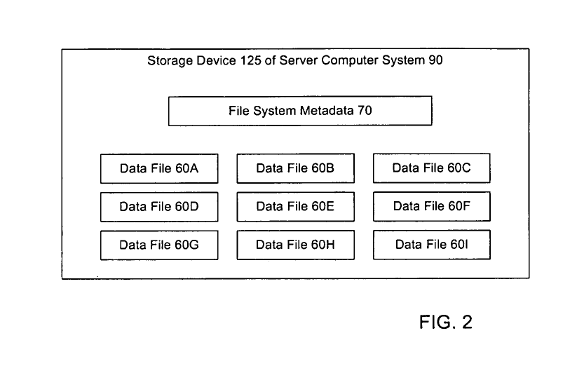

As illustrated in FIG. 2, each of the data files 60 may be stored on the server computer system 90 separately from each other and separately from the file system metadata 70. For example, rather than storing an image that encapsulates the data files 60, the data files 60 may be stored as separate entities from each other on the server computer system 90. For example, in some embodiments each data file 60 of the volume may be stored as a corresponding file on the server computer system 90. Similarly, the file system metadata 70 may also be stored as a file (or set of files) on the server computer system 90. For example, as described below, when backing up the volume, the client computer system 80 may create one or more files that represent the file system metadata 70 and transmit the one or more files to the server computer system 90 for storage.

For various reasons it may become necessary to restore the volume to the client computer system 80 after the volume has been backed up to the server computer system 90. For example, the one or more storage devices on which the volume is stored on the client computer system 80 may fail, or the volume may become corrupted. The volume data (the data files 60 and the file system metadata 70) stored on the server computer system 90 may enable the volume to be restored to or re-created on the client computer system 80 (or a new computer system). For example, since each data file 60 of the volume was backed up to the server computer system 90, the data files 60 stored on the server computer system 90 may be used to re-create the data files 60 on the client computer system 80 such that each data file 60 is identical to the state in which it existed at the time the volume was backed up to the server computer system 90.

The file system metadata 70 may also be used when restoring or re-creating the volume on the client computer system 80. The file system metadata 70 is information used by the file system to manage or implement the volume. For example, in some embodiments the file system metadata 70 may include data structures such as tables or records for each file and folder in the volume. For example, the file system metadata 70 may include information specifying block addresses or other storage locations of each data file 60 in the volume, as well as other properties of each data file 60. In some embodiments the file system metadata 70 may also include other types of information, such as information that enables the volume to be mounted or initialized during startup of the client computer system 80.

Since the file system metadata 70 was backed up to the server computer system 90, the file system metadata 70 stored on the server computer system 90 may be used in a restore operation to re-create the file system metadata 70 on the client computer system 80 such that the file system metadata 70 is identical to the state in which it existed at the time the volume was backed up to the server computer system 90.

In some embodiments the data files 60 of the volume and the file system metadata 70 of the volume may be used to create a volume image. A restore function may execute on the client computer system 80 in order to automatically apply the volume image to one or more storage devices of the client computer system 80 in order to completely restore or re-create the volume on the client computer system 80. The volume may be restored to the client computer system 80 without manual intervention or configuration such that the volume is in the same state as it was at the time the volume was backed up to the server computer system 90. For example, all the data files 60 of the volume may be restored to the client computer system, where each data file 60 is in the same state as it was at the time the volume was backed up to the server computer system 90. In some embodiments The file system metadata 70 may be used to restore the data files 60 so that the data files 60 are stored in the same storage or block locations on the hard disk drive (or other storage device) of the client computer system 80 as they were at the time the volume was backed up to the server computer system 90.

Performing a restore operation as described above may enable the volume to be completely and efficiently recovered, e.g., in the event of a disaster such as a hardware failure that causes the volume to be lost on the client computer system 80 and/or a software error that causes the volume to become corrupted.

In the event that it is necessary to restore the volume on the client computer system 80, in some embodiments the client computer system 80 may communicate with the server computer system 90 to retrieve the volume data via the network 84. A restore function of the client backup software (or another program) executing on the client computer system 80 may be operable to automatically restore or re-create the volume from the volume data. In some embodiments, the restore function may first create an image from the volume data and then apply the image to one or more storage devices of the client computer system 80 in order to restore the volume. In other embodiments, software executing on the server computer system 90 may first create an image from the volume data and then transmit the image to the client computer system 80 via the network 84, where software executing on the client computer system 80 may then apply the image to the one or more storage devices of the client computer system 80. In yet other embodiments, an image of the volume may be created from the volume data stored on the server computer system 90, and the image may be stored on one or more portable storage devices or mediums, such as one or more portable hard disk drives, one or more CDs, etc. The portable storage device(s) or medium(s) may then be physically shipped to the location of the client computer system 80 for use in restoring the volume.

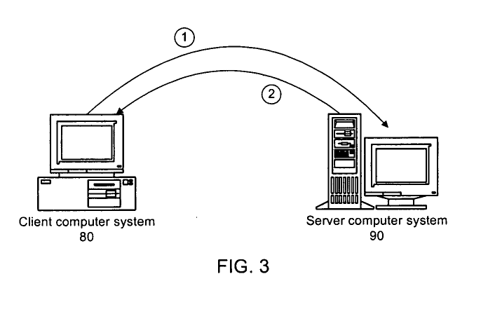

In addition to performing a complete restore of the volume on the client computer system 80, in some embodiments the volume data stored on the server computer system 90 may be used to restore individual data files 60 onto the client computer system 80. For example, a particular data file 60 may be restored on the client computer system 80 without restoring the other data files 60 and without restoring the file system metadata 70. For example, as illustrated by the arrow 1 in FIG. 3, the client computer system 80 may send a request specifying one or more desired data files 60 to the server computer system 90. In response, the server computer system 90 may return the specified data file(s) 60 to the client computer system 80, as illustrated by the arrow 2.

As discussed above, in some embodiments the data files 60 may be stored separately from each other on the server computer system 90. This may enable the server computer system 90 to easily and efficiently locate a particular data file 60 requested by the client computer system 80 and return the particular data file to the client computer system 80. For example, by storing the data files 60 separately from each other (e.g., as opposed to being encapsulated together with each other in a volume image) the server computer system 90 is not required to mount or analyze a volume image in order to find the requested data file 60, nor required to extract the requested data file 60 from the volume image.

Furthermore, in some embodiments it may be desirable to store the data files 60 on the server computer system 90 in an encrypted form. In some embodiments, before transmitting each data file 60 to the server computer system 90, the client backup software on the client computer system 80 may first encrypt the data file 60. Thus, each data file 60 may be individually encrypted and stored on the server computer system 90 in its encrypted form. In response to the client computer system 80 requesting a particular data file 60 to be restored, the server computer system 90 may simply return the particular data file 60 to the client computer system 80 in its encrypted form. The restore function of the client backup software on the client computer system 80 may then decrypt the received data file 60 before restoring it to the volume. Thus, the server computer system 90 may not possess and may not need the decryption keys for the data files 60. This may increase the security of the data files 60 stored on the server computer system 90, e.g., by preventing unauthorized decryption of the data files 60 or access to the data contained therein.

In some embodiments, after an initial backup operation of the volume on the client computer system 80 has been performed, a subsequent backup operation of the volume may be performed. Thus, the initial backup operation may operate to store information on the server computer system 90 representing a first point-in-time backup of the volume, where the first point-in-time backup represents the state of the volume at the time the initial backup operation is performed. Similarly, the subsequent backup operation may operate to store information on the server computer system 90 representing a second point-in-time backup of the volume, where the second point-in-time backup represents the state of the volume at the time the subsequent backup operation is performed.

In some embodiments the subsequent backup operation may operate to transmit to the server computer system 90 only the data files 60 that have changed since the initial backup operation was performed. Thus, data files 60 that have not changed since the initial backup operation was performed may not be transmitted to the server computer system 90, which may increase the efficiency of the subsequent backup operation and reduce the amount of network traffic.

As described above, in the initial backup operation the client computer system 80 may send file system metadata 70 to the server computer system 90 in addition to the data files 60, e.g., in the form of one or more files created from and representing the file system metadata of the volume. Similarly, in the subsequent backup operation the client computer system 80 may also send file system metadata 70 the server computer system 90, e.g., where the file system metadata 70 sent in the subsequent backup operation represents a change in the file system metadata of the volume. Thus, for each backup operation, the client computer system 80 may backup the current file system metadata of the volume such that the volume may later be restored in its current state if necessary.

For each respective backup operation, the client backup software on the client computer system 80 may create corresponding catalog information referencing the data files 60 in the volume and the file system metadata 70 for the respective backup operation. The client computer system 80 may transmit the catalog information to the server computer system 90, and the server computer system 90 may store the catalog information. The catalog information for each backup operation may represent a point-in-time backup of the volume by specifying which data files 60 are in the volume at the time the backup operation is performed, as well as specifying the file system metadata 70 of the volume at the time the backup operation is performed.

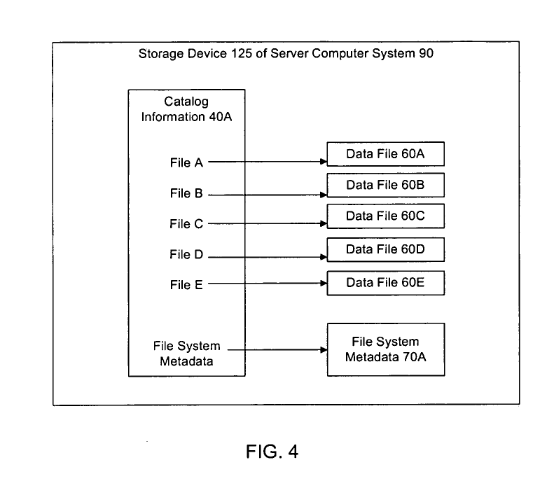

For example, suppose that when the initial backup operation is performed the volume on the client computer system 80 includes five data files respectively named “File A”, “File B”, “File C”, “File D”, and “File E”. Each of the five data files may be transmitted to the server computer system 90. As illustrated in FIG. 4, the server computer system 90 has stored the files on one or more storage devices 125, as data files 60A-60E. File system metadata 70A representing file system metadata of the volume at the time the initial backup operation is performed may also be transmitted to and stored on the server computer system 90. In addition, catalog information 40A may be transmitted to and stored on the server computer system 90. As illustrated in FIG. 4, the catalog information 40A specifies the data files in the volume and references each of the data files 60A-60E, as well as the file system metadata 70A. Thus, the catalog information 40A effectively represents a point-in-time backup of the volume, e.g., represents the state of the volume as it exists at the time the initial backup operation is performed.

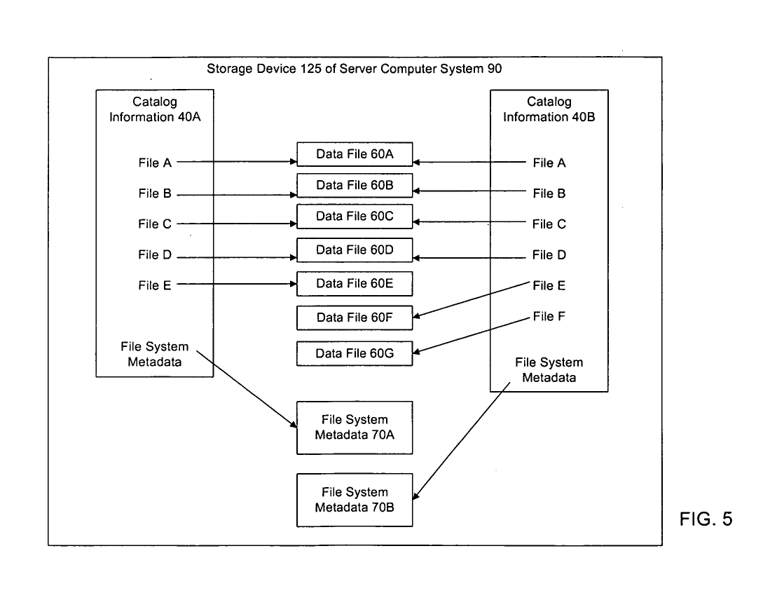

Now suppose that after the initial backup operation is performed, the data file named “File E” in the volume on the client computer system 80 is modified, and a new data file named “File F” is created in the volume. If another backup operation is then performed, the client backup software on the client computer system 80 may determine that “File E” was modified after the initial backup operation was performed, and thus may transmit the new version of “File E” to the server computer system 90. For example, as illustrated in FIG. 5, the server computer system 90 has stored a new data file 60F corresponding to the new version of “File E”. The client backup software may also determine that “File F” was created after the initial backup operation was performed, and thus may transmit “File F” to the server computer system 90. As illustrated in FIG. 5, the server computer system 90 has stored a new data file 60G corresponding to “File F”. The client backup software may also determine that the four data files, “File A”, “File B”, “File C”, and “File D” have not changed since the initial backup operation was performed. Thus, these four data files may not be transmitted to the server computer system 90.

In the second backup operation, the client backup software may also create file system metadata 70B representing file system metadata of the volume at the time the second backup operation is performed and transmit the file system metadata 70B to the server computer system 90. The client backup software may also transmit catalog information 40B to the server computer system 90. As illustrated in FIG. 5, the catalog information 40B may list each of the data files in the volume at the time the second backup operation is performed and may reference the corresponding data files 60 stored on the server computer system 90. For example, the catalog information 40B references the same data files 60A-60D as the catalog information 40A, since these data files still represent “File A”, “File B”, “File C”, and “File D” in the current state of the volume. However, since “File E” has changed, the catalog information 40B references the data file 60F corresponding to the new version of “File E” instead of the data file 60E corresponding to the old version of “File E”. The catalog information 40B also references the data file 60G corresponding to the new “File F”, as well as the file system metadata 70B. Thus, the catalog information 40B effectively represents another point-in-time backup of the volume, e.g., represents the state of the volume as it exists at the time the second backup operation is performed.

Thus, the system may allow the volume to be restored on the client computer system 80 as the volume exists at different points in time. The catalog information corresponding to any of the points in time at which backup operations have been performed may be used to re-create the volume.

In some embodiments the client backup software on the client computer system 80 may be operable to automatically communicate with the server computer system 90 to perform scheduled backups of the volume. For example, an administrator of the client computer system 80 may configure the client backup software to perform backups according to specified time criteria, such as daily, weekly, etc. If it becomes necessary to restore the volume to the client computer system 80, the administrator may select the desired point-in-time backup on the server computer system 90 to use for the restore operation.

As described above, in some embodiments, when an initial backup operation of the volume on the client computer system 80 is performed, each data file 60 in the volume may be transmitted to the server computer system 90. However, in other embodiments of the system, the server computer system 90 may be pre-seeded with common files so that transmission of certain files in the volume may be avoided even in the initial backup operation. For example, an administrator of the second computer system may store various common files (e.g., files commonly found on computer systems) on the server computer system 90, e.g., where the common files are not stored in response to a backup operation.

For example, the server computer system 90 may be pre-seeded with operating system files commonly used by many computer systems, as well as program files used by software applications commonly installed on computer systems. If the volume on the client computer system 80 includes operating system files, many of the operating system files may already be stored on the server computer system 90. Thus, instead of transmitting the operating system files to the server computer system 90, the catalog information created for the initial backup operation may simply reference the operating system files already stored on the server computer system 90. Similarly, if the volume on the client computer system 80 includes program files for a particular software application in common use, these program files may already be stored on the server computer system 90. Thus the catalog information created for the initial backup operation may simply reference the program files already stored on the server computer system 90.

In some embodiments the server computer system 90 may provide an online backup service for multiple customers or users. The server computer system 90 may include a common storage area 700 pre-seeded with common data files. The volume backup information for different customers or users may reference the common data files in the common storage area 700. In addition, each customer or user may have a private storage area 702. Data files for a given customer that are not already stored in the common storage area 700 may be stored in the private storage area 702 of the customer. In some embodiments, data files stored in the private storage area 702 of a given customer may not be accessible to other customers in order to provide security for each customer's private data.

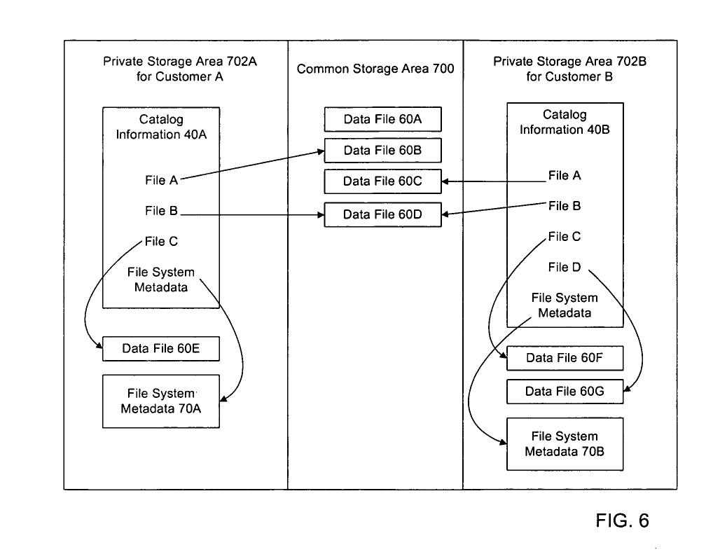

FIG. 6 illustrates a simple example in which data files 60A-60D are stored in a common storage area 700 of the server computer system 90. As shown, catalog information 40A corresponding to a point-in-time backup of a volume of a client computer system owned by a Customer A may be stored in a private storage area 702A, and catalog information 40B corresponding to a point-in-time backup of a volume of a client computer system owned by a Customer B may be stored in a private storage area 702B. The catalog information 40A references the data files 60B and 60D stored in the common storage area 700, the data file 60E stored in the private storage area 702A, and the file system metadata 70A stored in the private storage area 702A. Similarly, the catalog information 40B references the data files 60C and 60D stored in the common storage area 700, the data files 60F and 60G stored in the private storage area 702B, and the file system metadata 70B stored in the private storage area 702B.

Thus, in various embodiments the system may utilize various techniques to reduce the amount of data transmitted to the server computer system 90 during backup operations and avoid storing duplicate data on the server computer system 90, e.g., by transmitting only files that have changed since the previous backup operation and by pre-seeding the server computer system 90 with common files.

In further embodiments the system may implement additional techniques to further reduce the amount of data transmitted to the server computer system 90 and further reduce the amount of duplication of data stored on the server computer system 90. For example, if a new data file has been created in the volume since the previous backup operation, it is possible that the new data file is an identical copy of another data file in the volume, or that the new data file is an identical copy of another data file previously stored on the server computer system 90 in a previous backup operation. Thus, in some embodiments the client backup software on the client computer system 80 may communicate with the server computer system 90 to perform a de-duplication technique to avoid transmitting duplicate data files to the server computer system 90.

For example, before transmitting a data file to the server computer system 90, the client backup software may perform an algorithm based on data in the data file in order to compute an ID or signature for the data file. The ID or signature may include information useable to identify the data file. For example, in some embodiments a hash function may be applied to the data of the data file in order to generate a hash value used as the signature. In other embodiments, any of various other kinds of algorithms may be performed to generate the signature. In some embodiments the algorithm that is used may have the following properties: 1) For any two data files that have identical data, the algorithm will generate the same signatures for the data files. 2) For any two data files that do not have identical data, the algorithm will generate different signatures for the data files.

Thus, before transmitting a given data file to the server computer system 90, the client backup software may compute the signature for the data file and communicate with the server computer system 90 to determine whether the server computer system 90 already stores a data file having the same signature. If so then the data file may not be re-transmitted to the server computer system 90. Instead, the volume backup information stored on the server computer system 90 for the backup operation currently being performed may reference the existing data file on the server computer system 90. If however there is not already another data file on the server computer system 90 having the same signature then the data file may be transmitted to and stored on the server computer system 90.

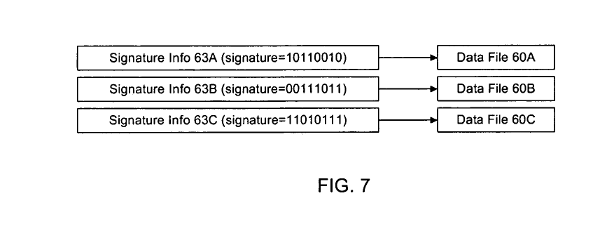

The server computer system 90 may store signature information 63 corresponding to each data file 60, where the signature information 63 for a given data file 60 specifies the signature of the data file 60. For example, FIG. 7 illustrates an example in which three data files 60A-60C and corresponding signature information 63A-63C are stored on the server computer system 90. The signature information 63 for the respective data files may be used in determining whether the server computer system 90 already stores a data file having a particular signature.

In some embodiments the server computer system 90 may execute specialized server-side backup software with which the client backup software executing on the client computer system 80 communicates in order to determine whether a data file having a particular signature is already stored on the server computer system 90. For example, in some embodiments the client backup software may pass the server-side backup software a signature in a query. In response to receiving the signature, the server-side backup software may examine the signature information 63 stored on the server computer system 90 in order to look for a matching signature.

In other embodiments the server computer system 90 may execute standard file server software without executing specialized server-side backup software. For example, the data files stored on the server computer system 90 may be stored according to a directory structure and named according to a naming convention that allows the client backup software to determine whether a data file having a given signature is already stored on the server computer system 90 by simply traversing the directory structure and examining the names of the data files stored on the server computer system 90.

Also, in some embodiments the server computer system 90 may be operable to transmit to the client backup software on the client computer system 80 information indicating which data files 60 are already stored on the server computer system 90, e.g., where the information specifies the signatures of the data files 60 on the server computer system 90. Thus, the client computer system 80 may utilize this information locally to determine which data files 60 are already stored on the server computer system 90 without requiring round-trip communication between the client computer system 80 and the server computer system 90 for each data file.

In some embodiments, duplication of data on the server computer system 90 may be performed on a per-file basis, e.g., by utilizing data file signatures as described above. In other embodiments, the duplication of data on the server computer system 90 may be performed at a more granular level, e.g., based on data file segments. For example, the client backup software may execute to split a data file in the volume into a plurality of segments 66. For each segment 66 of the data file, an algorithm based on data in the segment may be performed in order to compute an ID or signature for the segment 66.

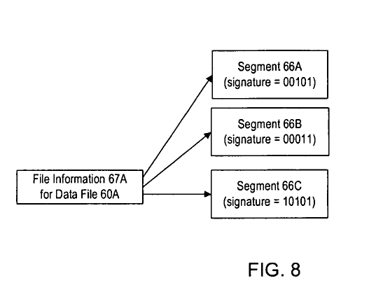

Thus, the client backup software may transmit the data file segments 66 to the server computer system 90, and each data file segment 66 may be stored separately from the other data file segments 66. FIG. 8 illustrates an example in which a data file 60A has been split into three segments 66A-66C. Each segment 66 may be transmitted to and stored on the server computer system 90 along with information indicating the respective segment signature. The server computer system 90 may also store file information 67A referencing the segments 66A-66C that compose the data file 60A.

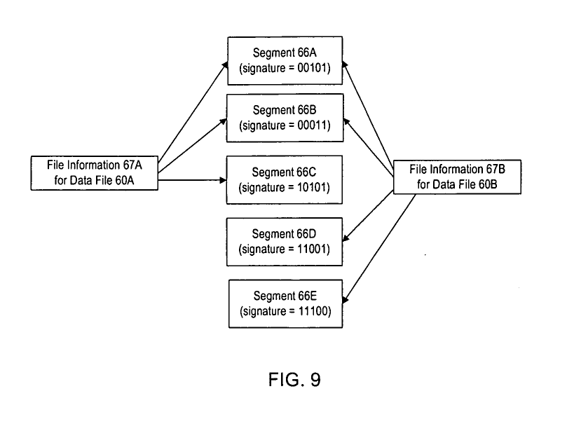

If another data file includes one or more segments identical to segments already stored on the server computer system 90 then the identical segments may not be re-transmitted to the server computer system. Instead, the segments already stored on the server computer system 90 may simply be referenced. For example, suppose that after a first backup operation has been performed in which the segments 66A-66C are stored on the server computer system 90 as described above with reference to FIG. 8, the client backup software performs a second backup operation where a new data file 60B has been added to the volume. The client backup software may split the data file 60B into a plurality of segments and calculate signatures for the segments. Before transmitting each segment to the server computer system 90, the client backup software may communicate with the server computer system 90 to determine whether a segment having the same signature is already stored on the server computer system 90. In the example of FIG. 9, the client backup software splits the data file 60B into four segments, where two of the segments are identical to the segments 66A and 66B already stored on the server computer system 90, and two of the segments are not identical to any segment already stored on the server computer system 90. Thus, the two non-identical segments are transmitted to the server computer system 90 and referenced by file information 67B for the data file 60B. The file information 67B also references the two previously stored segments 66A and 66B.

Thus, the use of data file segments and segment signatures may further reduce the degree to which data is duplicated on the server computer system 90 and further reduce the amount of data transmitted in the volume backup operations. In further embodiments the client backup software may be further operable to utilize delta compression techniques in order to further reduce the degree of data duplication and transmission.

As discussed above, when a backup operation is performed, the client backup software may send file system metadata 70 to the server computer system 90 to be stored in association with the point-in-time backup information. The file system metadata 70 includes information used to manage or implement the volume. For example, in some embodiments the file system metadata 70 may include data structures such as tables or records for each file and folder in the volume, as well as other types of file system information, such as information that enables the volume to be mounted or initialized during startup of the client computer system 80. In a restore operation, the file system metadata 70 stored on the server computer system 90 may be used to re-create the file system metadata for the volume so that the file system metadata is identical to the state in which it existed at the time the volume was backed up to the server computer system 90.

In various embodiments, the file system metadata 70 may include various kinds of information, e.g., according to which particular file system manages the volume. As one example, the volume may be formatted according to an NTFS file system. In this example, the file system metadata 70 of the volume may include the NTFS Partition Boot Sector as well as various NTFS System files. The NTFS system files may include files such as the Master File Table (MFT) file, the Volume file, the Attribute definitions file, the Cluster bitmap file, etc. In various embodiments the client backup software may utilize any of various techniques in order to extract the file system metadata 70 from the volume and package the file system metadata 70 in a form suitable for transmission to the server computer system 90, e.g., by creating one or more files in which the file system metadata 70 is stored.

It is noted that system files which the file system uses to manage or implement the volume (e.g., NTFS system files in the case of an NTFS volume) are not considered to be data files 60. Data files 60 include any files in the volume other than files which the file system uses to manage or implement the volume, such as operating system files, application program files, user files, etc.

In some embodiments, when performing a backup operation, the client backup software may operate to first create an image of the volume, where the image includes the data files 60 of the volume and the file system metadata 70 of the volume. Each data file 60 may be extracted from the image of the volume and separately transmitted to the server computer system 90. After the data files 60 have been extracted from the image, the remaining file system metadata 70 in the image may be transmitted to the server computer system 90. In other embodiments the client backup software may not create an image of the volume, but may instead simply read the data files from the one or more storage devices on which the volume is stored and transmit the data files to the server computer system 90. The client backup software may also be operable to package the file system metadata 70 into one or more files or other suitable form for transmission to the server computer system 90 without first creating an image of the volume.

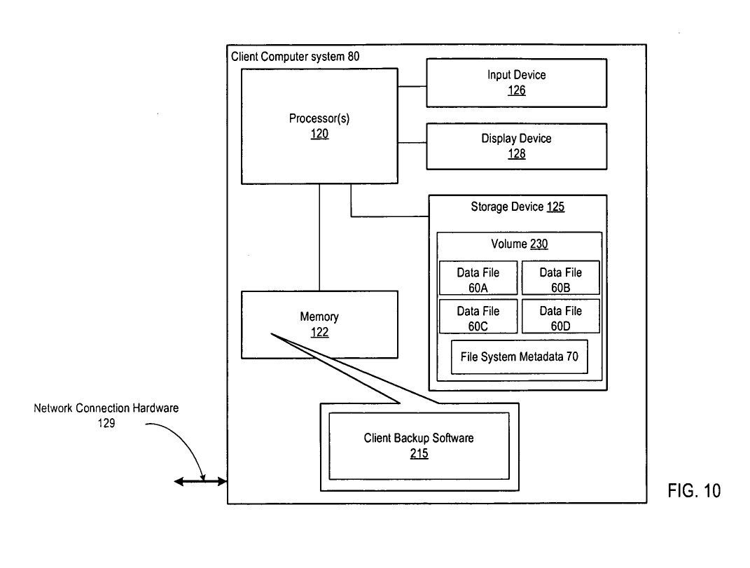

Referring now to FIG. 10, one embodiment of the client computer system 80 is illustrated. It is noted that FIG. 10 is intended as an example of the client computer system 80, and in various embodiments any type of client computer system 80 may be utilized.

In this example, the client computer system 80 includes a processor 120 coupled to a memory 122. In some embodiments, the memory 122 may include one or more forms of random access memory (RAM) such as dynamic RAM (DRAM) or synchronous DRAM (SDRAM). However, in other embodiments, the memory 122 may include any other type of memory instead or in addition.

The memory 122 may be configured to store program instructions and/or data. In particular, the memory 122 may store various client backup software 215. The client backup software 215 is executable by the processor 120 to communicate with the server computer system 90 to perform a backup operation such as described above to backup the volume 230.

The processor 120 is representative of any type of processor. For example, in some embodiments, the processor 120 may be compatible with the x86 architecture, while in other embodiments the processor 120 may be compatible with the SPARC™ family of processors. Also, in some embodiments the client computer system 80 may include multiple processors 120.

The computer system 80 may also include or be coupled to one or more storage devices 125. In various embodiments the storage device(s) 125 may include any of various kinds of devices operable to store data, such as optical storage devices, disk drives, tape drives, flash memory devices, etc. As one example, the storage device(s) 125 may be implemented as one or more disk drives configured independently or as a disk storage system.

Although the volume 230 is illustrated in this example as being stored on a single storage device 125, in other embodiments the volume 230 may be distributed across multiple storage devices 125 of the client computer system 80. As described above, the volume 230 includes a plurality of data files 60, as well as file system metadata 70.

The client computer system 80 may also include one or more input devices 126 for receiving user input from a user of the client computer system 80. The input device(s) 126 may include any of various types of input devices, such as keyboards, keypads, microphones, or pointing devices (e.g., a mouse or trackball). The client computer system 80 may also include one or more display devices 128 for displaying output to the user. The display device(s) 128 may include any of various types of devices for displaying information, such as LCD screens or monitors, CRT monitors, etc.

The client computer system 80 may also include network connection hardware 129 through which the client computer system 80 connects to the network 84. The network connection hardware 129 may include any type of hardware for coupling the client computer system 80 to the network, e.g., depending on the type of network 84.

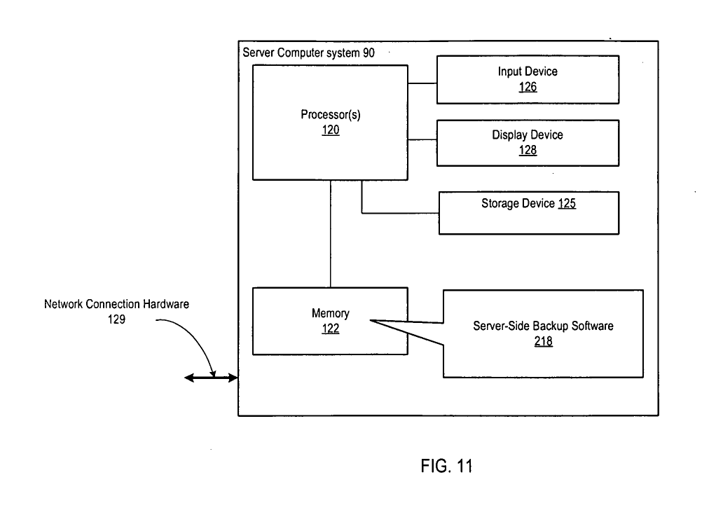

Referring now to FIG. 11, one embodiment of the client computer system 90 is illustrated. It is noted that FIG. 11 is intended as an example of the server computer system 90, and in various embodiments any type of server computer system 90 may be utilized.

The server computer system 90 may include similar features as the client computer system 80, such as one or more processors 120, memory 122, one or more input devices 126, one or more display devices 128, network connection hardware 129, etc. The memory 122 may store server-side backup software 218 executable by the processor 120 to communicate with the client backup software 215 on the client computer system 80 to implement backup operations such as described above. The server computer system 90 may also include one or more storage devices 125 in which volume backup information is stored in response to the backup operations, as described above.

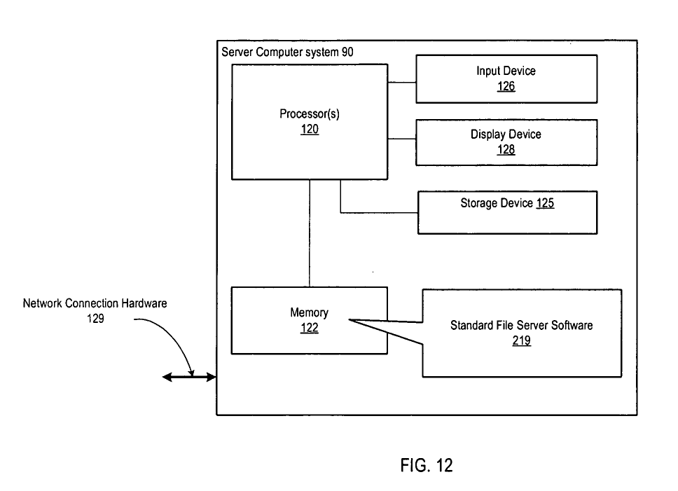

As discussed above, in some embodiments the server computer system 90 may simply execute standard file server software without executing specialized backup software. FIG. 12 illustrates another embodiment of the server computer system 90, in which the memory 122 stores standard file server software 219 instead of the specialized server-side backup software 218.

It is further noted that when the client backup software on the client computer system 80 initiates the backup operation, the client backup software may perform a function to create a snapshot of the volume which reflects the current state of the volume at the particular point in time at which the backup operation is initiated. This may allow the client computer system 80 to continue to perform other functions that modify the volume data while still preserving the volume data as it exists at the time at which the backup operation is initiated. For example, copy-on-write techniques may be utilized so that portions of the volume data that are modified during the backup operation are copied to another location so that the original volume data can be read for the backup operation.

It is noted that various embodiments may further include receiving, sending or storing instructions and/or data implemented in accordance with the foregoing description upon a computer-accessible storage medium. Generally speaking, a computer-accessible storage medium may include any storage media accessible by a computer during use to provide instructions and/or data to the computer. For example, a computer-accessible storage medium may include storage media such as magnetic or optical media, e.g., disk (fixed or removable), tape, CD-ROM, DVD-ROM, CD-R, CD-RW, DVD-R, DVD-RW, etc. Storage media may further include volatile or non-volatile memory media such as RAM (e.g. synchronous dynamic RAM (SDRAM), Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. In some embodiments the computer may access the storage media via a communication means such as a network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A system comprising:
a first computer system configured to perform a first backup operation to back up a volume to a second computer system, wherein the volume is formatted according to a particular file system, wherein the volume includes a plurality of data files and metadata of the file system, wherein the first computer system is configured to perform the first backup operation by:
determining which of the plurality of data files are not already stored on the second computer system;
transmitting to the second computer system only the data files that are not already stored on the second computer system;
transmitting to the second computer system the metadata of the file system; and
transmitting to the second computer system catalog information specifying the plurality of data files in the volume and associating the plurality of data files in the volume with the metadata of the file system.

2. The system of claim 1, further comprising:
the second computer system, wherein the second computer system is configured to:
store the data files transmitted from the first computer system in the first backup operation, wherein each data file is stored as a separate data file in a file system of the second computer system;
store the file system metadata transmitted from the first computer system in the first backup operation separately from the data files transmitted from the first computer system in the first backup operation; and
store the catalog information transmitted from the first computer system in the first backup operation separately from the data files and the file system metadata transmitted from the first computer system in the first backup operation.

3. The system of claim 2, wherein storing the file system metadata transmitted from the first computer system comprises storing the file system metadata in one or more data files separately from the data files of the volume.

4. The system of claim 2,
wherein the second computer system is configured to store a plurality of common data files;
wherein the first computer system determining which of the plurality of data files are not already stored on the second computer system comprises the first computer system determining which of the plurality of data files are not among the plurality of common data files stored on the second computer system.

5. The system of claim 1, wherein the first computer system is further configured to:
create one or more files that include the metadata of the file system;
wherein transmitting the metadata of the file system comprises transmitting the one or more files that include the metadata of the file system.

6. The system of claim 1, wherein the catalog information references the data files transmitted from the first computer system in the first backup operation and one or more data files already stored on the second computer system before the first backup operation.

7. The system of claim 1,
wherein the first computer system is configured to transmit the data files that are not already stored on the second computer system separately from each other and separately from the metadata of the file system.

8. The system of claim 1,
wherein the first computer system is configured to determine that a first data file of the plurality of data files is not already stored on the second computer system by computing a signature for the first data file and determining that a data file having the signature is not already stored on the second computer system.

9. The system of claim 1, wherein the first computer system is further configured to:
for each respective data file transmitted to the second computer system, encrypt the respective data file before transmitting the respective data file to the second computer system.

10. The system of claim 1, wherein the first computer system is further configured to:
for a first data file transmitted to the second computer system, utilize a delta compression technique to reduce an amount of data of the first data file transmitted to the second computer system.

11. The system of claim 1, wherein the first computer system is further configured to:
after performing the first backup operation, communicate with the second computer system to request a particular file of the plurality of data files; and
receive the particular file from the second computer system in response to the request.

12. The system of claim 1,
wherein the volume is formatted according to an NTFS file system;
wherein the metadata of the file system includes one or more of:
a Master File Table file of the volume;
an NTFS Partition Boot Sector of the volume.

13. The system of claim 1, wherein the first computer system is further configured to:
for each respective data file transmitted to the second computer system, split the respective data file into a plurality of segments, wherein transmitting the respective data file to the second computer system comprises transmitting each segment of the plurality of segments to the second computer system.

14. A computer-accessible storage medium storing program instructions executable to implement a method comprising:
performing a first backup operation to back up a volume of a first computer system to a second computer system, wherein the volume is formatted according to a particular file system, wherein the volume includes a plurality of data files and metadata of the file system, wherein performing the first backup operation comprises:
determining which of the plurality of data files are not already stored on the second computer system;
transmitting to the second computer system only the data files that are not already stored on the second computer system;
transmitting to the second computer system the metadata of the file system; and
transmitting to the second computer system catalog information specifying the plurality of data files in the volume and associating the plurality of data files in the volume with the metadata of the file system.

15. A method comprising:
performing a first backup operation to back up a volume of a first computer system to a second computer system, wherein the volume is formatted according to a particular file system, wherein the volume includes a plurality of data files and metadata of the file system, wherein performing the first backup operation comprises:
determining which of the plurality of data files are not already stored on the second computer system;
transmitting to the second computer system only the data files that are not already stored on the second computer system;
transmitting to the second computer system the metadata of the file system; and
transmitting to the second computer system catalog information specifying the plurality of data files in the volume and associating the plurality of data files in the volume with the metadata of the file system.
